(19) United States
(12) Patent Application Publication
(10) Pub. No.: US 2011/0102475 A1
(43) Pub. Date: May 5, 2011

(54) DISPLAY APPARATUS, BACKLIGHT UNIT, AND BACKLIGHT PROVIDING METHOD FOR CONTROLLING A PLURALITY OF LED STRINGS

(75) Inventors: Pankaj AGARWAL, Suwon-si (KR); Sang-hoon LEE, Suwon-si (KR); Sung-jin CHOI, Gunpo-si (KR); Tae-hoon KIM, Suwon-si (KR); Myoung-jun LEE, Bucheon-si (KR); Youn-hee KIM, Seoul (KR)

(73) Assignee: SAMSUNG ELECTRONICS CO., LTD., Suwon-si (KR)

(21) Appl. No.: 12/794,285

(22) Filed: Jun. 4, 2010

(30) Foreign Application Priority Data
Nov. 4, 2009 (KR) 10-2009-0105994

(51) Int. Cl. G09G 5/10; H05B 37/02

(52) U.S. Cl. 345/690; 315/192

(57) ABSTRACT

A display apparatus, a backlight unit, a backlight providing method for controlling a plurality of light emitting diode (LED) strings are provided. The display apparatus includes a display panel, and a backlight unit (BLU) which projects backlight onto the display panel, wherein the BLU includes a plurality of light emitting diode (LED) strings, and a power supply unit which supplies minimum voltage from among the voltages needed to operate the plurality of LED strings to the plurality of LED strings. Therefore, the plurality of LED strings can have the same luminance.

### CROSS-REFERENCE TO RELATED APPLICATIONS

This application claims priority from Korean Patent Application No. 10-2009-0105994, filed on Nov. 4, 2009 in the Korean Intellectual Property Office, the disclosure of which is incorporated herein by reference in its entirety.

### BACKGROUND

1. Field

Apparatuses and methods consistent with the exemplary embodiments relate to a display apparatus, a backlight unit, a backlight providing method for controlling a plurality of light emitting diode (LED) strings, and more particularly, to a display apparatus, a backlight unit, and a backlight providing method for supplying power to operate a plurality of LED strings to have the same luminance.

2. Description of the Related Art

Recently, as multimedia devices such as televisions (TVs), cell phones and notebook computers have developed, the demand for technical development of flat panel display devices has been increased. As flat panel display devices, plasma display panels (PDPs), liquid crystal displays (LCDs), field emission displays (FEDs) and vacuum fluorescent displays (VFDs) have been developing.

Among them, LCDs are electrical elements which change diverse electrical information generated by diverse devices into visual information using a change in a penetration ratio of liquid crystal according to ane applied voltage. Recently, LCDs have received an increased amount of attention due to the development of technology for mass production of the LCDs, ease of use of the LCD driving means, and realization of high image quality.

However, LCDs which are penetrating display elements display images by adjusting the amount of light penetrating a liquid crystal layer using anisotropy of reflection of liquid crystal molecules. Accordingly, in order to display images, backlight should be installed as a light source which penetrates the liquid crystal layer.

A backlight unit (BLU) consists of light sources to generate backlight, and driving elements to drive the light sources. The light sources are arrayed to emit backlight onto the LCD efficiently, and the driving elements are implemented in appropriate numbers so as to drive the light sources efficiently.

As the light sources of the BLU, light emitting diodes (LEDs) having high luminance, longer lifetime, and no heat emission, receive attention instead of cold cathode fluorescent lamps (CCFLs). LEDs can adjust luminance using the driving power supplied to the LEDs. Methods for helping improvement of visibility of LCDs and reduction of power consumption have been suggested by adjusting a power supply unit.

In particular, in order to obtain uniform luminance from the respective LEDs, the electrical current is maintained regularly so that luminance can be stabilized. In addition, operating respective LED to have the same luminance is crucial to a BLU having a plurality of LED strings.

However, the respective LEDs may have a different electrical current required to maintain appropriate luminance due to errors caused in the manufacture of the LEDs. The difference in required electrical current is an object that has to be resolved in order to have uniform luminance in the BLU having a plurality of LED strings.

### SUMMARY OF THE EXEMPLARY EMBODIMENTS

Exemplary embodiments address at least the above problems and/or disadvantages and other disadvantages not described above. Also, the exemplary embodiments are not required to overcome the disadvantages described above, and an exemplary embodiment may not overcome any of the problems described above.

An aspect of the exemplary embodiments provides a BLU having a plurality of LED strings in which a power supply unit supplies, to the LED strings, the voltages needed to operate the respective LED strings to have appropriate luminance, so that the plurality of LED strings can have the same luminance.

Another aspect of the exemplary embodiments provides a BLU having uniform luminance and a display apparatus using the same, thereby resulting in cost savings of an LED driver, reduction in the size of a DC-DC converter, and reduction of power consumption.

Therefore, a display apparatus, a backlight unit, a BLU providing method for supplying power which enables a plurality of LED strings to have the same luminance.

According to an exemplary embodiment, there is provided a display apparatus including an image processing unit which processes an input image, a display panel which displays the processed input image, and a backlight unit (BLU) which projects backlight onto the display panel, wherein the BLU includes a plurality of light emitting diode (LED) strings, a power supply unit which supplies reference voltage to the plurality of LED strings, and a plurality of voltage compensation units which are disposed between the plurality of LED strings and the power supply unit, and compensate voltage for uniform luminance of the plurality of LED strings.

The plurality of voltage compensation units may compensate for luminance deviations generated in manufacturing the plurality of LED strings.

The power supply unit may supply a minimum voltage from among voltages needed to operate the respective LED strings to have a preset luminance, as the reference voltage.

The plurality of voltage compensation units may compensate for deviations between voltages needed to operate the respective LED strings to have a preset luminance, and the reference voltage.

The plurality of voltage compensation units may be connected to the plurality of LED strings in series respectively, and the plurality of voltage compensation units may be connected to the power supply unit in parallel.

The plurality of voltage compensation units may be implemented as any of DC-DC converters, AC-DC converters, and charge pumped drivers.

According to another exemplary embodiment, there is provided a backlight unit (BLU) including a plurality of light emitting diode (LED) strings, a power supply unit which supplies a reference voltage to the plurality of LED strings, and a plurality of voltage compensation units which are disposed between the plurality of LED strings and the power supply unit, and compensate voltage for uniform luminance of the plurality of LED strings.

The plurality of voltage compensation units may compensate for luminance deviations generated in manufacturing the plurality of LED strings.

The power supply unit may supply a minimum voltage from among voltages needed to operate the respective LED strings to have a preset luminance, as the reference voltage.

The plurality of voltage compensation units may compensate for deviations between voltages needed to operate the respective LED strings to have a preset luminance, and the reference voltage.

The plurality of voltage compensation units may be connected to the plurality of LED strings in series respectively, and the plurality of voltage compensation units may be connected to the power supply unit in parallel.

The plurality of voltage compensation units may be implemented as any of DC-DC converters, AC-DC converters, and charge pumped drivers.

According to yet another exemplary embodiment, there is provided a backlight providing method including supplying a reference voltage to each of the plurality of light emitting diode (LED) strings, and compensating the voltage for uniform luminance of the plurality of LED strings.

In compensating the voltage, luminance deviations generated in manufacturing the plurality of LED strings may be compensated.

In supplying the reference voltage, a minimum voltage from among voltages needed to operate the respective LED strings to have a preset luminance may be supplied as the reference voltage.

In compensating the voltage, deviations between voltages needed to operate the respective LED strings to have a preset luminance and the reference voltage may be compensated.

### BRIEF DESCRIPTION OF THE DRAWINGS

The above and/or other aspects of the exemplary embodiments will be more apparent by describing certain exemplary embodiments with reference to the accompanying drawings, in which:

FIG. 1 is a block diagram illustrating a display apparatus according to an exemplary embodiment;

FIG. 2 is a block diagram illustrating a configuration of a BLU according to an exemplary embodiment;

FIG. 3A is a graph illustrating an electrical current-luminance property;

FIG. 3B is a graph illustrating a voltage-electrical current property;

FIG. 4 is a block diagram illustrating a configuration of a BLU according to another exemplary embodiment;

FIG. 5 is a graph illustrating a voltage-electrical current property in operating an LED according to an exemplary embodiment;

FIG. 6 is a block diagram illustrating a configuration of a BLU according to yet another exemplary embodiment; and

FIG. 7 is a flow chart illustrating a backlight providing method according to an exemplary embodiment.

### DETAILED DESCRIPTION OF EXEMPLARY EMBODIMENTS

Certain exemplary embodiments will now be described in greater detail with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, the exemplary embodiments can be practiced without those specifically defined matters. Also, well-known functions or constructions are not described in detail since they would obscure the exemplary embodiments with unnecessary detail.

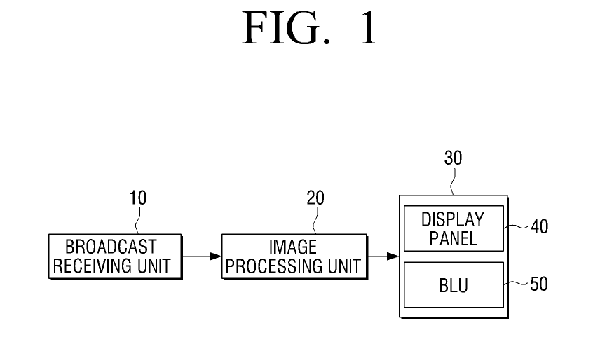

FIG. 1 is a block diagram illustrating a display apparatus according to an exemplary embodiment. As illustrated in FIG. 1, the display apparatus may include a broadcast receiving unit 10, an image processing unit 20, and a display 30. The display 30 may include a display panel 40 and a backlight unit (BLU) 50.

The broadcast receiving unit 10 may be tuned to a channel of broadcast which is received terrestrially, through a cable, wirelessly or in a wired manner. The broadcast receiving unit 10 sets one of multiple channels as an input channel, and receives a broadcast signal via the set channel.

The image processing unit 20 performs signal-processing, such as video decoding, video scaling, frame rate conversion (FRC), etc, of broadcast content output from the broadcast receiving unit 10.

The display panel 40 may be implemented as a liquid crystal display (LCD), but is not limited thereto.

The display panel 40 displays broadcast content processed by the image processing unit 20. The BLU 50 projects backlight onto the display panel 40 so that the display panel 40 can display an image.

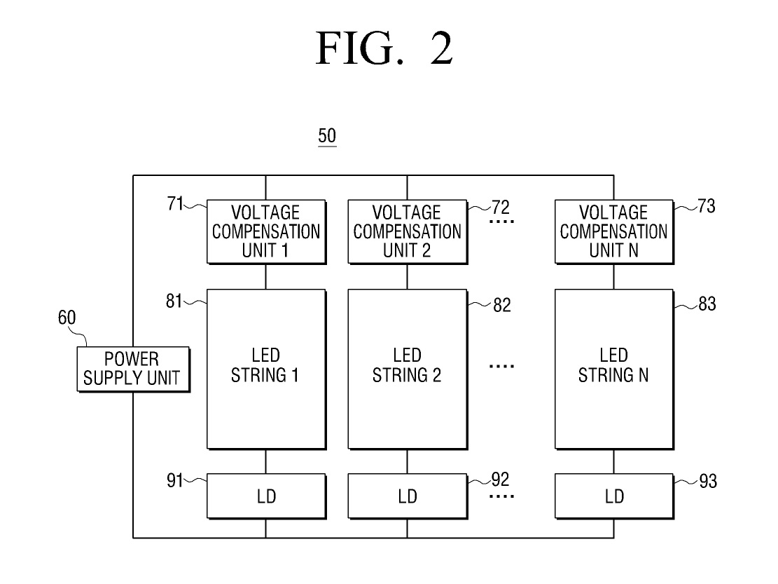

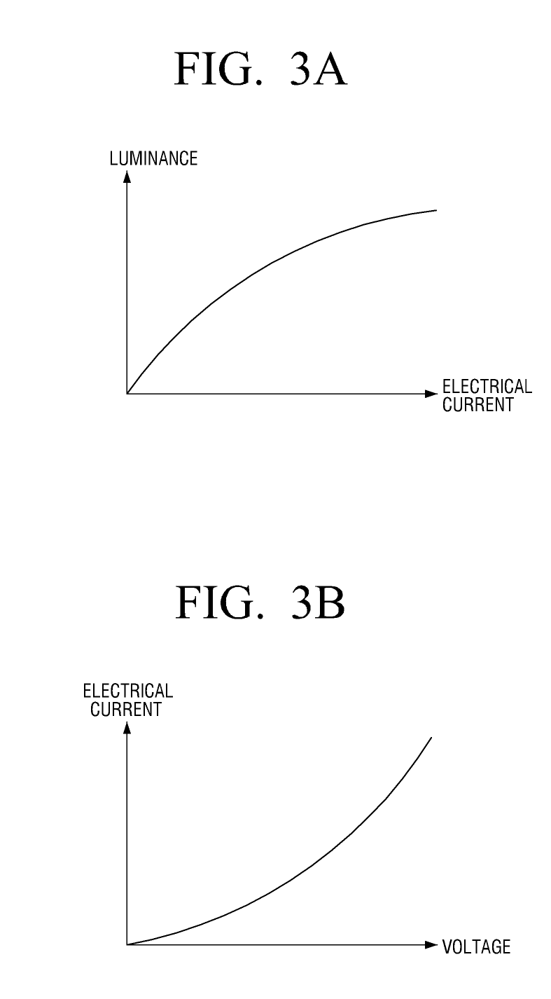

An operating method of the display apparatus according to an exemplary embodiment is described with reference to FIGS. 2, 3A, and 3B.

FIG. 2 is a block diagram illustrating a configuration of the BLU 50 according to an exemplary embodiment, FIG. 3A is a graph illustrating an electrical current-luminance property between the electrical current supplied to an LED string and luminance of an LED, and FIG. 3B is a graph illustrating a voltage-electrical current property when operating the LED.

The BLU 50 may include a power supply unit 60, ‘N’ number of voltage compensation units 71, 72 and 73, ‘N’ number of LED strings 81, 82 and 83, and ‘N’ number of linear driers (LDs) 91, 92 and 93. The BLU 50 using the LED according to an exemplary embodiment requires a driving circuit capable of regularly maintaining the electrical current flowing into the LED. The driving circuit is called a linear driver (LD). The LDs 91, 92 and 93 are connected to the LED strings 81, 82 and 83 respectively in series.

As illustrated in FIG. 3A, as the electrical current applied to the LED strings 81, 82 and 83 increases, the luminance of the LED increases. Accordingly, in order to obtain appropriate luminance, applied electrical current needs to be adjusted appropriately. In addition, referring to the graph illustrated in FIG. 3B, as the voltage applied to the LED increases, the electrical current increases.

Consequently, in order to adjust the luminance, the electrical current should be adjusted, and in order to adjust the electrical current, the voltage applied to the LED should be adjusted.

The power supply unit 60 applies a driving voltage to each LED string 81, 82 and 83 so that each LED string 81, 82 and 83 can operate. If the conditions for operating the respective LED strings 81, 82 and 83 are ideally the same, the power supply unit 60 applies the same voltage to each LED string 81, 82 and 83, so each LED string 81, 82 and 83 can have the same luminance.

However, even if the same voltage is applied to the ‘N’ number of LED strings 81, 82 and 83, the ‘N’ number of LED strings 81, 82 and 83 cannot have the same luminance due to a manufacturing error, so a device which compensates for the error is required. Accordingly, as illustrated in FIG. 2, the voltage compensation units 71, 72 and 73 are connected to the ‘N’ number of LED strings 81, 82 and 83 respectively so as to apply a voltage needed to operate the ‘N’ number of LED strings 81, 82 and 83 to have the same luminance.

The power supply unit 60 may be implemented as an AC-DC converter or a DC-DC converter, or may also be any kind of device capable of supplying power to the LED strings.

In particular, the power supply unit 60 supplies the minimum voltage from among the voltages needed to operate the respective LED strings 81, 82 and 83 to have the preset luminance.

The voltage compensation units 71, 72 and 73 apply necessary voltages to the LED strings 81, 82 and 83 respectively to compensate for deviations between the voltages needed to operate the respective LED strings 81, 82 and 83 to have the preset luminance, and the minimum voltage supplied by the power supply unit 60.

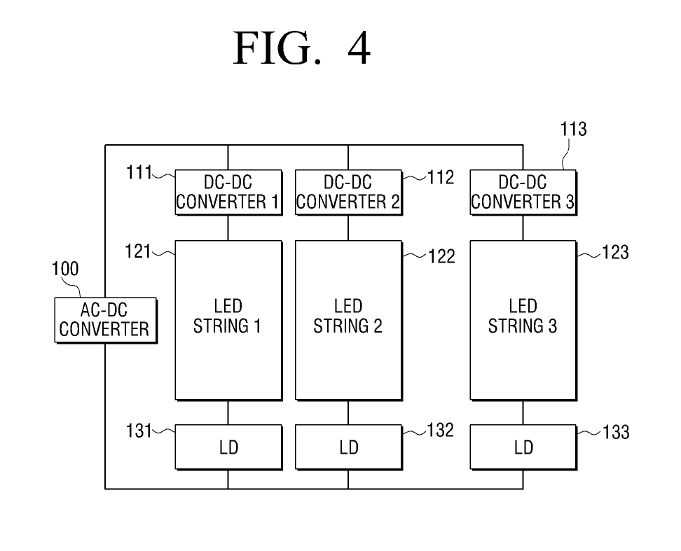

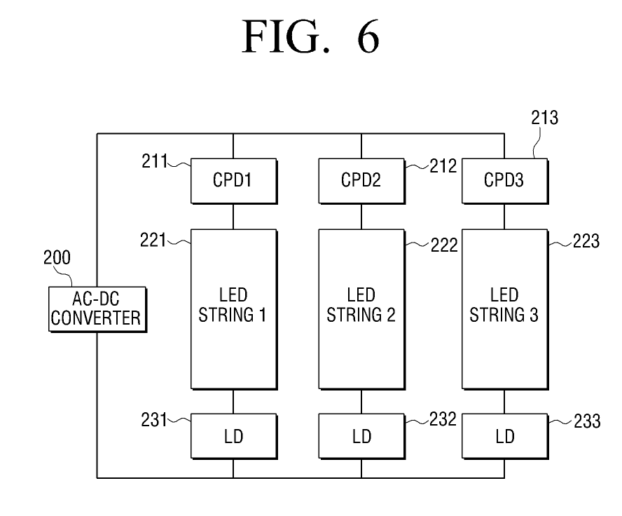

The voltage compensation units 71, 72 and 73 may be implemented as a DC-DC converter, an AC/DC converter, or a charge pumped driver (CPD), but is not limited thereto. Such configurations are illustrated in FIGS. 4 and 6. Further, the voltage compensation units 71, 72 and 73 may be implemented on an integrated circuit (IC) capable of compensating voltage as well as any other circuit capable of doing the same.

As illustrated in FIG. 2, the power supply unit 60 is connected to the LED strings 81, 82 and 83 in parallel, and the LED strings 81, 82 and 83 are connected to the voltage compensation units 71, 72 and 73 in series. However, connection is not limited thereto. The technical idea of the exemplary embodiments can be applied to circuits having other configurations of the equivalent value.

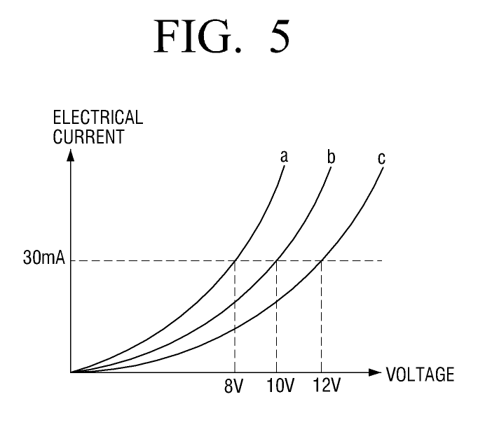

Hereinafter, an exemplary embodiment is described in greater detail with reference to FIGS. 4 and 5.

In FIG. 4, the power supply unit 60 is implemented as an AC-DC converter 100, and the voltage compensation units 71, 72 and 73 are implemented as a DC-DC converter 1 111, a DC-DC converter 2 112, and a DC-DC converter 3 113 respectively. Likewise, the AC-DC converter 100 is connected to an LED string 1 121, an LED string 2 122, and an LED string 3 123 in parallel, and the DC-DC converter 1 111, the DC-DC converter 2 112, and the DC-DC converter 3 113 are connected to the LED string 1 121, the LED string 2 122, and the LED string 3 123 respectively in series. The LED strings 121, 122 and 123 are connected to the linear drivers 131, 132 and 133 respectively in series.

In FIG. 5, “a” is a curve indicating a voltage-electrical current property of the LED string 1 121, “b” is a curve indicating an voltage-electrical current property of the LED string 2 122, and “c” is a curve indicating an voltage-electrical current property of the LED string 3 123. These three curves may be different due to a manufacturing error. Actual numerical values may be different from the numerical values shown in FIG. 5, but description is given below using exaggerated numerical values to obtain a better understanding of the exemplary embodiments.

As illustrated in FIG. 3A, the electrical current is proportional to the luminance to a certain degree. It is assumed that electrical current value corresponding to the present luminance is 30 mA, and voltage which the LED strings 121, 122 and 123 need is 8V, 10V and 12V. That is, the LED string 1 121, the LED string 2 122, and the LED string 3 123 need voltage of 8V, 10V and 12V to have the preset luminance.

The AC-DC converter 100 which is a power supply unit supplies voltage of 8V, which is the minimum voltage from among the above voltages.

Subsequently, deviations between the supplied voltage and the voltages needed to operate the respective LED strings 121, 122 and 123 to have the preset luminance are calculated. In this exemplary embodiment, the deviation for the LED string 1 121 is calculated 0V, the deviation for the LED string 2 122 is calculated 2V, and the deviation for the LED string 3 123 is calculated 4V.

The DC-DC converters 111, 112 and 113 compensate the calculated deviations so as to adjust the voltages applied to the LED strings 121, 122 and 123. In this exemplary embodiment, the DC-DC converters 111, 112 and 113 compensate 0V, 2V and 4V, and apply 0V, 2V and 4V to the LED strings 121, 122 and 123 respectively, so that the LED strings 121, 122 and 123 can obtain 8V, 10V and 12V, which are the voltages needed to have the preset luminance.

In a modified exemplary embodiment, the AC-DC converter 100 supplies reference voltage, and the DC-DC converters 111, 112 and 113 compensates the deviations between the reference voltage and the voltages needed to operate the respective LED strings 121, 122 and 123 to have the preset luminance.

That is, if the reference voltage is 5V, the AC-DC converter 100 supplies 5V to the DC-DC converters 111, 112 and 113, the DC-DC converter 1 111 compensates 3V(8V−5V), the DC-DC converter 2 112 compensates 5V(10V−5V), and the DC-DC converter 3 113 compensates 7V(12V−5V).

Accordingly, in the modified exemplary embodiment, the voltage applied to the LED strings 121, 122 and 123 also becomes 8V, 10V and 12V.

In FIG. 6, the voltage compensation units according to another exemplary embodiment are implemented as charged pumped drivers (CPDs) 211, 212 and 213. The voltage compensation units may be replaced with other elements capable of compensating the voltage, and may be implemented on an IC.

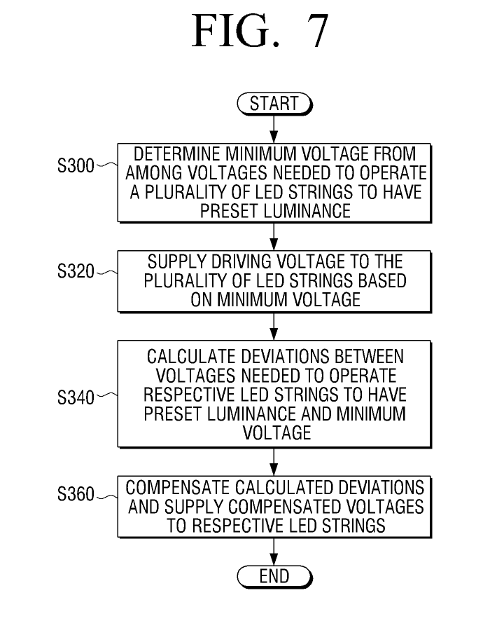

FIG. 7 is a flow chart illustrating a backlight providing method according to an exemplary embodiment.

The minimum voltage is determined from among the voltages needed to operate a plurality of LED strings so that the plurality of LED strings have a preset luminance (operation S300). The power supply unit 60 supplies driving voltage to the plurality of LED strings based on the minimum voltage (operation S320).

Subsequently, deviations between the voltages needed to operate the respective LED strings to have the preset luminance, and the minimum voltage are calculated (operation S340).

Lastly, the calculated deviations are compensated and the compensated voltages are supplied to the respective LED strings (S360).

As can be appreciated from the above description of the BLU having the plurality of LED strings, the power supply unit and the voltage compensation units which are connected to the LED strings adjust voltages supplied to the LED strings, so that the LED strings can have voltages needed to have the same luminance.

The foregoing exemplary embodiments are merely exemplary and are not to be construed as limiting the exemplary embodiments. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus, comprising:
an image processing unit which processes an input image;
a display panel which displays the processed input image; and
a backlight unit (BLU) which projects backlight onto the display panel,
wherein the BLU comprises:
a plurality of light emitting diode (LED) strings;
a power supply unit which supplies reference voltage to each of the plurality of LED strings; and
a plurality of voltage compensation units, which are connected between the plurality of LED strings and the power supply unit, and perform voltage compensation for uniform luminance of the plurality of LED strings.

2. The display apparatus according to claim 1, wherein the plurality of voltage compensation units compensate luminance deviations generated during manufacture of the plurality of LED strings.

3. The display apparatus according to claim 1, wherein the power supply unit supplies a minimum voltage, from among voltages which operate the respective LED strings to have a preset luminance, as the reference voltage.

4. The display apparatus according to claim 1, wherein the plurality of voltage compensation units compensate for deviations between voltages which operate the respective LED strings to have a preset luminance, and the reference voltage.

5. The display apparatus according to claim 1, wherein the plurality of voltage compensation units are respectively connected to the plurality of LED strings in series, and are connected to the power supply unit in parallel.

6. The display apparatus according to claim 1, wherein the plurality of voltage compensation units are implemented as at least one of DC-DC converters, AC-DC converters, and charge pumped drivers.

7. A backlight unit (BLU), comprising:
a plurality of light emitting diode (LED) strings;
a power supply unit which supplies a reference voltage to each of the plurality of LED strings; and
a plurality of voltage compensation units which are connected between the plurality of LED strings and the power supply unit, and compensate voltage for uniform luminance of the plurality of LED strings.

8. The BLU according to claim 7, wherein the plurality of voltage compensation units compensate luminance deviations generated during manufacture of the plurality of LED strings.

9. The BLU according to claim 7, wherein the power supply unit supplies a minimum voltage, from among voltages which operate the respective LED strings to have a preset luminance, as the reference voltage.

10. The BLU according to claim 7, wherein the plurality of voltage compensation units compensate for deviations between voltages which operate the respective LED strings to have a preset luminance, and the reference voltage.

11. The BLU according to claim 7, wherein the plurality of voltage compensation units are respectively connected to the plurality of LED strings in series, and are connected to the power supply unit in parallel.

12. The BLU according to claim 7, wherein the plurality of voltage compensation units are implemented as at least one of DC-DC converters, AC-DC converters, and charge pumped drivers.

13. A backlight providing method, comprising:
supplying reference voltage to each of a plurality of light emitting diode (LED) strings; and
compensating voltage for uniform luminance of the plurality of LED strings.

14. The method according to claim 13, wherein in compensating the voltage, luminance deviations generated during manufacture of the plurality of LED strings are compensated.

15. The method according to claim 13, wherein in supplying the reference voltage, minimum voltage from among voltages needed to operate the respective LED strings to have a preset luminance, is supplied as the reference voltage.

16. The method according to claim 13, wherein in compensating the voltage, deviations between voltages needed to operate the respective LED strings to have a preset luminance and the reference voltage are compensated.

17. A backlight unit (BLU) comprising:
a plurality of light emitting diode (LED) strings;
a plurality of voltage compensation units;
a plurality of linear drivers; and
a power supply unit,
wherein the power supply unit supplies a minimum voltage, from among voltages which operate the LED strings at a preset luminance, to the LED strings, and
the voltage compensation units apply voltages to the LED strings to compensate for deviations between the voltages which operate the LED strings at the preset luminance, and the minimum voltage.

18. The backlight unit of claim 17, wherein the plurality of voltage compensation units are respectively connected to the plurality of LED strings in series.

19. The backlight unit of claim 17, wherein the plurality of voltage compensation units are connected to the power supply unit in parallel.
